(19) United States
(12) Patent Application Publication
(10) Pub. No.: US 2007/0053678 A1
(43) Pub. Date: Mar. 8, 2007

(54) Alarm systems for cameras

(75) Inventor: Kenji Yamane, Saitama-shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/512,236

(22) Filed: Aug. 30, 2006

(30) Foreign Application Priority Data
Sep. 2, 2005 (JP) 2005-254603

(51) Int. Cl. G03B 17/18

(52) U.S. Cl. 396/286

(57) ABSTRACT

An alarm system for a camera changeable between a normal mode in which exposure is made in response to operation of a shutter release button and a premonitory mode in which exposure is made with a delay of time comprises an acoustic or a visible alarm device which raises an alarm by a countdown for acquainting a photographer with a timing of exposure during progress of the delay time in the premonitory mode.

### BACKGROUND OF THE INVENTION

1. Field of the Invention

The present invention relates to an alarm system for a camera.

2. Description of Related Art

There have been known various types of cameras such as a photographic camera for use with a silver halide film and a digital camera which records digital data of an object picture. There has also been known a mobile phone equipped with a digital camera built therein. Such a camera is getting around to acquiring adaptability to dark scenes resulting from incorporation of a bright and sensitive lens. However, because there is a limit to cameras of this type due to a cost requirement, a size requirement and/or an anti-noise requirement or because it is hard for the cameras to adapt substantially dark scenes, photographers have little choice but to perform a picture taking at a lower shutter speed in order to make correct exposure. One of the problems encountered by the camera when taking a picture at a lower shutter speed is a camera shake, one of casual factors of a blur picture, unless keeping a tight hold of the camera during picture taking. In particular, a camera shake readily occurs in a digital camera and a mobile phone equipped with a digital camera which are often kept off from a photographer's face when making exposure watching a subject image on a monitor screen.

In order to prevent an occurrence of camera shake, there have been proposed image blur correction devices or camera shake compensation devices. Such a device described in, for example, Japanese Laid-Open Patent Application Nos. 2-280131 and 5-165078 comprises an actuator operative to shift one or more correction lens elements of a taking lens in a radial direction so as to cancel motion of an image on an image plane according to a camera shake which is detected in terms of vibrations or motion of a camera body. Specifically, while the correction is performed by varying a shutter release time lag after centering the correction lens elements in a radial direction and starting exposure at the point that the blur correction is enabled as a result of a comparison between a signal representative of a detected camera shake and a signal representative of operation of the actuator for correction. The term “shutter release time lag” as used herein shall mean and refer to the delay time between operation of the shutter release member and a start of actual exposure.

Although this type of blur correction device is one of effective anti-blurring means for defusing blur of a subject image that is caused due to a camera shake, one of the problems encountered by the blur correction device is structural complexity which often leads to a high cost. Moreover, the blur correction device is difficult to be downscaled and, in consequence, unreasonable to be incorporated in a digital camera built in a mobile phone.

### SUMMARY OF THE INVENTION

It is therefore an object of the present invention to provide an alarm system for a camera changeable between a normal photographic mode in which exposure is made immediately in response to operation of a shutter release button and a premonitory photographic mode in which exposure is delayed a predetermined period of time. The alarm system comprises signal generating means for generating a trigger signal in response to operation of a release button of the camera which triggers actuation of the exposure means of the camera, control means for delaying actuation of the exposure means a predetermined period of time from a point of time of generation of the triggering signal in the delayed photographic mode, and alarm means for raising an alarm for acquainting a photographer with a timing of exposure during progress of the predetermined period of time in the delayed photographic mode. The alarm system may be provided with mode switch means for selectively switching the camera between the normal photographic mode and the delayed photographic mode.

According to preferred embodiments, the alarm means comprises acoustic alarm means for sounding a voice alarm or otherwise visual alarm means for providing light flashing on and off or a visual numerical character altering in descending order, by which a photographer is acquainted with a timing of exposure. More specifically, the acoustic alarm means comprises a built-in speaker for delivering a countdown voice and volume control means for controlling a sound volume of the built-in speaker in such a way as to switch the built-in speaker between a small voice audible for a photographer and a loud voice audible for a person to be photographed besides the photographer. The acoustic alarm means may comprise an external voice output unit such as an earphone or a headphone detachably connected to the system. Further, the acoustic alarm means may comprise in combination with the built-in speaker. In this case, it is preferred for the acoustic alarm means to further comprise switch means for rendering the built-in speaker only ineffective when the external voice output unit is connected.

The alarm means, acoustic or visual, it is preferred to provide an alarm through a countdown by voice or countdown by a counting number going down in order.

Since the alarm system provides an alarm for acquainting the photographer with a timing of exposure during progress of the predetermined period of time which exposure is delayed from operation of the shutter release button, the photographer can make a tight hold of the camera timely in concurrence with exposure, so as to prevent an occurrence of a camera shake during picture taking.

### BRIEF DESCRIPTION OF THE DRAWINGS

The foregoing and other objects and features of the present invention will be clearly understood from the following detailed description when reading with reference to the accompanying drawings wherein same parts or mechanisms are denoted by the same reference numerals throughout the drawings and in which:

FIG. 1 is a perspective front view of a camera equipped either an alarm system according to an embodiment of the present invention;

FIG. 2 is a rear view of the camera;

FIG. 3 is a block diagram of an essential part of internal structure of the camera;

FIG. 4 is a flowchart illustrating a photographing sequence of the camera;

FIG. 5 is a rear view of the camera equipped with an alarm lampas optical alarm means that is disposed in closely vicinity of an eyepiece window of a viewfinder,

FIG. 6 is a perspective front view of the camera equipped with an earphone as detachable voice output means;

FIG. 7 is a perspective front view of the camera equipped with an earphone as detachable voice output means and a built-in speaker,

FIG. 8 is an illustration showing a circuit including a voice output jack and the speaker of the camera shown in FIG. 7;

FIG. 9 is an illustration showing a circuit including a volume controller, besides the voice output jack and the speaker of the camera shown in FIG. 7;

FIG. 10 is a perspective front view of the camera which is capable of automatically switching the camera between an normal photographic mode and a premonitory photographic mode in which exposure is delayed a predetermined period of time; and

FIG. 11 is a flowchart illustrating a mode switching sequence of the camera.

### DETAILED DESCRIPTION OF THE PREFERRED EMBODIMENTS

In the following description, parts or means which are not direct importance to the invention and parts or means which are purely of conventional construction will not be described in detail. For example, details of the exposure means or mechanisms, the metering means, the focusing means, the sound generating circuit, etc. which are necessary to the camera will not be set out in detail since construction and operation can easily be arrived at by those skilled in the art.

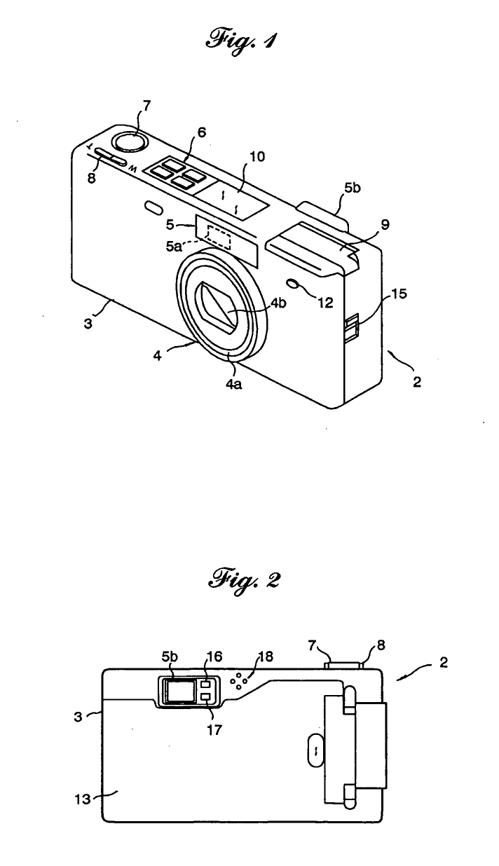

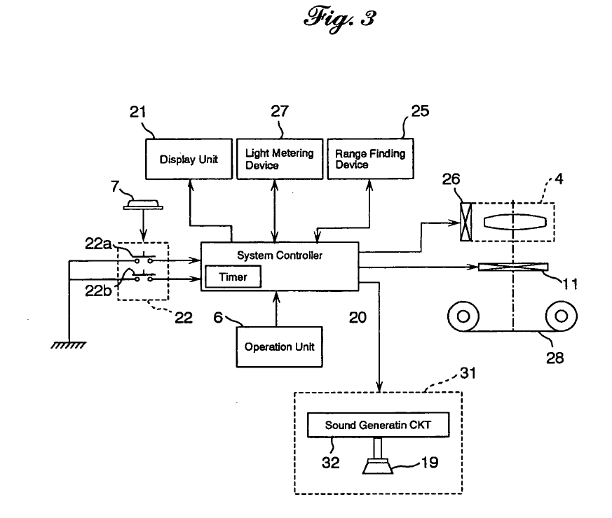

Referring to the accompanying drawings in detail, and in particular, to FIGS. 1 and 2 showing a camera 2 equipped with acoustic alarm means for sounding a voice alarm for acquainting a photographer with a timing of exposure according to an embodiment of the present invention, the camera 2 has a camera body 3 provided with a retractable lens barrel 4a incorporated therein and a viewfinder 5 disposed in a front wall thereof. The lens barrel 4a, which has a taking lens system 4 (see FIG. 3) incorporated therein, is movable between a retracted position where the lens barrel 4a is positioned within the camera body 3 as shown in FIG. 1 and a projected position where the lens barrel 3 projects from the front wall. The lens barrel 4a is provided with a lens barrier 4b for covering the taking lens system 4 in the retracted position and uncover it in the projected position The camera body 3 is further provided with an operation unit 6, a shutter release button 7, a zoom button 8, a strobe unit 9 and LCD 10 disposed in a top wall thereof The operation unit 6 has various button switches including at least a power on/off button for turning on and off power, a mode selection button for selectively changing the camera 2 between a normal photographic mode and a premonitory photographic mode which will be described later, and a film speed setting button for setting a film speed of a film loaded in the camera 2. As is well known in the art, the shutter release button 7 is adapted to be depressed half-way (half-way depression) for light metering and focusing prior to exposure and pressed all the way down (full-stroke pressing) for exposure. The term “normal photographic mode” as used herein shall mean and refer to the mode wherein exposure is made immediately in response to full-stroke pressing of the shutter release button 7. In the normal photographic mode, the camera 2 performs metering of subject brightness and focusing on a subject in response to half-way depression of the shutter release button 7 and forces an exposure device 11 (see FIG. 3) such as a programmed shutter to open and close so as thereby to expose a film in immediate response to full-stroke pressing of the shutter release button 7. The term “premonitory photographic mode” as used herein shall mean and refer to the mode wherein exposure is delayed a predetermined period of time (for example a few seconds) following full-stroke pressing of the shutter release button 7 and an alarm for acquainting the photographer with a start of exposure is given during progress of the predetermined period of time, namely for an interval between full-stroke pressing of the shutter release button 7 and a start of exposure. In this instance, the term “exposure” includes not only optical exposure of a photographic or silver halide film but also accumulation of electric charges on an image sensor such as CCD of a digital still camera. In the premonitory photographic mode, the camera 2 makes exposure with a delay of the predetermined period of time in response to full-stroke pressing of the shutter release button 7 after having focused the taking lens 4 on a photographic subject in response to half-way depression of the shutter release button 7 and gives an alarm by, for example, a countdown voice in order to acquaint the photographer with a start timing of exposure. The voice alarm can be performed by a voice counting down starting with a count of “three” and ending with a count of “zero.” The countdown may be started with another count of, for example, “five” and ended up with a count of, for example, “one.” A voice of the ending count, namely “zero” or “one” is almost parallelized with a start of exposure. The camera 2 may be enabled to allow the photographer to select starting and ending counts of the voice countdown, to select any one of prepared service languages such as Japanese, English, Chinese, French, etc. for the voice countdown, and to select any one of prepared voice tones such as “lively voice,” “steady voice,” “masculine voice,” “woman's voice,” etc.

The zoom button 8 which comprises a bi-directional seesaw type switch is pushed in order to zoom in or out a subject image. Specifically, when the zoom button 8 is pushed at one of opposite ends (which is marked with a T in FIG. 1) with a finger, the taking lens system 4 is operated toward a telephotograph side, i.e. a zoom-out side. On the other hand, when the zoom button 8 is pushed at another end (which is marked with a W in FIG. 1) with a finger, the taking lens system 4 is operated toward a wide angle side, i.e. a zoom-in side. The zoom button 8 automatically returns to its neutral position when the finger is taken off.

The strobe unit 9 is movable between a working position wherein a lighting window is exposed and directed toward a photographic subject and a rest position wherein the lighting window is placed within the camera body 3. Specifically, the lighting window pops up when a push button 12 installed in a front wall of the camera body 3 is pushed and is placed within the camera body 3 when it is forced down with a finger. The strobe unit 9 in the working position provides flash light toward a photographic subject through the lighting window in synchronism with exposure when the detected subject brightness is below a predetermined level. LCD 10 displays various photographic information including a selected photographic mode, a speed of a loaded film, a number of available exposures, etc thereon.

As shown in FIG. 2, the camera body 3 is provided with an eyepiece window 5b of the viewfinder 5 disposed in a rear wall thereof, a back cover 13 and a cover lock/unlock knob 15. The back cover 13 is hinged to the camera body 3 so as to move between an open position wherein an internal structure of the camera 2 including a cartridge chamber, a film take-up chamber and a film passageway between these chambers are exposed and a closed position wherein the interior of the camera body 3 is light-tightly covered The cover lock/unlock knob 15 is installed in a side wall of the camera body 3 for slide movement When sliding the cover lock/unlock knob 15 downward, the back cover 13 is unlocked and moves to the open position so as to enable loading of a film cartridge in the cartridge chamber or unloading it from the cartridge chamber. On the other hand, when forcing the back cover 13 to the camera body 3, the back cover 13 forces the lock knob 15 upward and then downward automatically to be locked in the closed position.

There are provided indicator lamps 16 and 17 disposed in the close vicinity of the eyepiece window 5b. One of the indicator lamps, namely a charge indicator lamp 16, indicates a charged state of a main capacitor of the strobe unit 9 when lighted and the other, namely a focus indicator lamp 17, indicates completion of focus adjustment of the taking lens system 4 when lighted Sound holes 18 are formed near the eyepiece window 5b in the rear wall of the camera body 3. The camera body 3 is further provided with a speaker 19 (see FIG. 3) disposed behind the sound holes 18 which sounds a countdown voice to acquaint the photographer viewing a photographic subject through the viewfinder with a timing of exposure.

Referring to FIG. 3 schematically illustrating an internal structure of the camera 2, a system controller 20 comprises a CPU, a ROM in which programs have been installed, a RAM used as a work memory which temporarily stores necessary data for execution of various sequential jobs therein, an I/O device for handling input and output of signals between various functional devices of the camera 2, a timer 20a for counting a time from the point of shutter release in the premonitory photographic mode, etc. The system controller 20 controls at least an display 21, a range finding device 25, a light metering device 27 and a voice generation unit 31 functioning as prealarm means besides a lens drive unit 26 and an exposure device 11 in response to operation signals provided by the operation unit 6 and the shutter release button 7.

The operation unit 6 provides signals for the system controller 20 according to operation thereof, then, the system controller 20 controls the functional devices to operate according to the operation signals, respectively. The shutter release button 7 cooperates with a combination switch 22 comprising two switches, namely a first switch 22a which comes on by half-way depression of the shutter release button 7 and a second switch 22b which comes on by full-stroke pressing of the shutter release button 7. The first switch 22a provides a preparatory signal for actuating the range finding device 25 through the system controller 20 when it comes on. The second switch 22b provides a trigger signal for actuation of the exposure device 11 through the system controller 20 when it comes on.

The indicator 21, which comprises an LCD 10 and a driver for driving the LCD 10, displays photographic information on the LCD 10 under control by the system controller 20.

The range finding device 25, which is actuated by a preparatory signal provided by the first switch 22a when the shutter release button 7 is depressed half-way, makes a measurement of a subject distance to a principal subject by means of a triangulation method and provides a signal representative of the measured subject distance (subject distance signal) for the system controller 20. The system controller 20 receiving the subject distance signal causes the lend drive unit 26 to move one or more than one lens elements of the taking lens system 4 in an axial direction for focusing and zooming.

The light metering device 27, which is actuated by a preparatory signal provided by the first switch 22a when the shutter release button 7 is depressed half-way in the normal photographic mode or immediately before exposure in the premonitory photographic mode, makes a measurement of brightness of the principal subject and provides a signal representative of the measured subject brightness (subject brightness signal) for the system controller 20. The system controller 20 receiving the subject brightness signal determines a correct exposure value, i.e. a combination of a shutter speed and an aperture size, according to the subject brightness and then causes the exposure device 11, e.g. a programmed shutter, to open and close at the shutter speed and the aperture value for exposure of a film 28.

The system controller 20 actuates the exposure device 11 to perform exposure of the film 28 immediately after having received a trigger signal provided by the second switch 22b upon full-stroke pressing of the shutter release button 7 in the normal photographic mode. On the other hand, the system controller 20 actuates the exposure device 11 to perform exposure after a lapse of the predetermined period of time from the point of reception of the trigger signal provided by the second switch 22b upon full-stroke pressing of the shutter release button 7 in the premonitory photographic mode. Concurrently, the system controller 20 provides a plurality of, for example three, vocalization command signals at regular intervals of time for the voice generation unit 31 during progress of the predetermined period of time which is monitored by the timer 20a. The voice generation unit 31, which generates a countdown voice as often as receiving the vocalization command signals during progress of the predetermined period of time, comprises a voice generation circuit 32 for driving the speaker 19. Specifically, the voice generation circuit 32 generates voice signals based on preinstalled voice data when receiving vocalization command signals and sends the voice signals so as thereby to cause the speaker 19 to sound a countdown voice from a starting count of “three” to an ending count of “zero” with an increase in the number of received voice signals. As was previously described, as soon as the speaker 19 sounds a countdown voice of “zero,” the exposure device 11 is actuated to make exposure of the film 28.

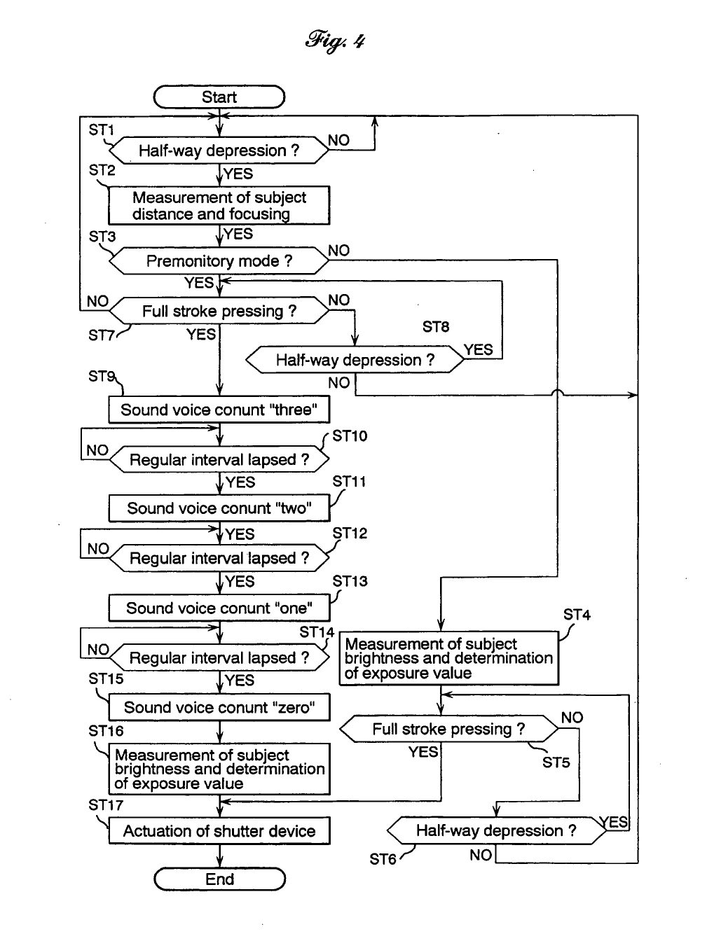

The operation of the camera depicted in FIGS. 1 to 3 is best understood by reviewing FIG. 4, which is a flowchart illustrating a control routine for CPU of the system controller 20. When the photographer makes half-way depression of the shutter release button 7 viewing a scene through the viewfinder 5 after selection of either one of the available modes, i.e. the normal photographic mode and the premonitory photographic mode, through operation of the operation unit 6, the first switch 22a comes on to provide a preparatory signal for the system controller 20. When the system controller 20 receives the preparatory signal, the sequence logic commences. Then, the control proceeds to step ST1 to make a judgment as to whether a preparatory signal has been received. This judgment is repeated until the preparatory signal is received. Subsequently, when the preparatory signal is received in step ST1, the range finding device 25 is actuated to make a measurement of a subject distance to a principal subject in step ST2 and drives the lend drive unit 26 to move lens elements of the taking lens system 4 according to the measured subject distance so as thereby to focus the taking lens 4 on the principal subject Subsequently, in step ST3, a judgment is made as to whether the camera 2 is set in the premonitory photographic mode. When the judgment is answered in the negative (NO), this indicates that the camera 2 is in the normal photographic mode, then, the control proceeds to step ST4 wherein the light metering device 27 is actuated to make a measurement of subject brightness. The system controller 22 determines an exposure value, i.e. a combination of a shutter speed and an aperture size, according to the measured subject brightness. Subsequently, in step ST5, a judgment is made as to whether the shutter release button 7 is pressed all the way down, in other words, whether a trigger signal has been received. When the judgment is answered in the negative (NO), then, a judgment is made in step ST6 as to whether a preparatory signal is present, i.e. whether the shutter release button 7 remains depressed half-way. Then, the control returns to step ST5 for another judgment as to full-stroke pressing of the shutter release button 7 when the judgment is answered in the affirmative (YES) or to step ST1 for restarting the control routine when the judgment is answered in the negative (NO).

When the judgment made in step ST5 is answered in the affirmative (YES), this indicates that the shutter release button 7 is pressed all the way down for making exposure, then, the system controller 20 drives the exposure device 11 so as thereby to perform exposure of the film 28 at the exposure value in step ST17 and, then, terminates the control routine. Accordingly, the camera 2 in the normal photographic mode performs exposure of the film 28 without any delay immediately in response to full-stroke pressing of the shutter release button 7.

On the other hand, when the judgment made in step ST3 is answered in the affirmative (YES), this indicates that the camera 2 is in the premonitory photographic mode, then, a judgment is made in step ST7 as to whether the shutter release button 7 is pressed all the way down, in other words, whether a trigger signal has been received. When the judgment is answered in the negative (NO), then, a judgment is made in step ST8 as to whether a preparatory signal is present i.e. whether the shutter release button 7 remains depressed half-way. Then, the control returns to step ST1 for restarting the control routine when the judgment is answered in the negative (NO) or to step ST9 when the judgment is answered in the affirmative (YES).

In step ST9 to which the control proceeds when full-stroke pressing of the shutter release button 7 is made, the system controller 20 provides a first vocalization command signal for the voice generation circuit 32 of the voice generation unit 31 when receiving a trigger signal so as thereby to cause the speaker 19 to sound a starting count of “three.” Similarly, the system controller 20 provides a second vocalization command signal for the voice generation circuit 32 of the voice generation unit 31 so as thereby to cause the speaker 19 to sound a count of “two” in step ST11 after having waited a lapse of a regular interval of time in step ST10, and further a third vocalization command signal for the voice generation circuit 32 of the voice generation unit 31 so as thereby to cause the speaker 19 to sound a count of “one” in step ST13 alter having waited a lapse of a regular interval of time in step ST12. Subsequently, the system controller 20 provides a forth vocalization command signal for the voice generation circuit 32 of the voice generation unit 31 so as thereby to cause the speaker 19 to sound an ending count of “zero” in step ST15 after having waited a lapse of a regular interval of time in step ST14. In parallel with sounding the count of “zero,” the system controller 22 actuates the light metering device 27 to make a measurement of subject brightness and determines an exposure value according to the measured subject brightness in step ST16 and then drives the exposure device 11 so as thereby to perform exposure of the film 28 at the exposure value in step ST17. Then, the control routine is terminated.

Just as described above, in the premonitory photographic mode, the camera 2 counts down from “three” to “zero” at regular intervals by voice through the speaker 19 in the predetermined period of time starting full-stroke pressing of the shutter button 7 and performs exposure of the film 28 immediately after the count of “zero.” Since the photographer can predict definitely a timing of exposure on a voice of countdown, it is easy for the photographer to take care to hold the camera 2 without a camera shake at exposure. In this premonitory photographic mode, although an exposure value is determined immediately before exposure based on a measured subject brightness (step ST16) after focusing made subsequently to half-way depression of the shutter release button 7, the determination of exposure value may be made at any desired timing such as a timing of half-way depression of the shutter release button 7 or at a timing during a countdown.

The following description will be directed to other embodiments of the present invention, in which parts which are denoted by the same reference numerals as those in the previous embodiment will not be described in detail.

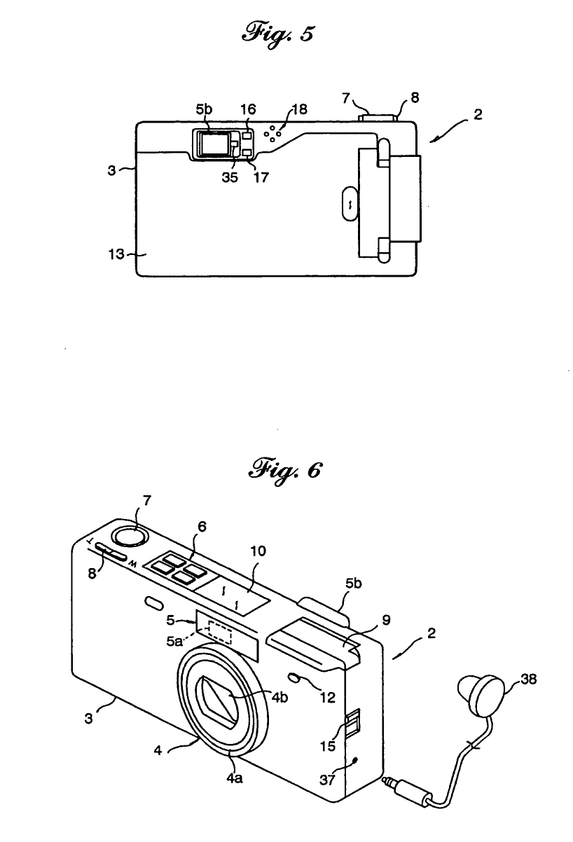

FIG. 5 shows a camera equipped with visual alarm means functioning as prealarm means for visually acquainting a photographer with a timing of exposure by flashing light according to another embodiment of the present invention, besides the voice alarm means described in the previous embodiment A camera body 2 is provided with an alarm lamp 35 disposed as visual alarm means within the viewfinder 5 or in close vicinity to an eyepiece window 5b of the viewfinder 5. This alarm lamp 35 is adapted to flash on and off in synchronism with every voice count The visual alarm means enables a photographer to be certainly acquainted with a timing of exposure even in a crowd or noisy surroundings.

The visual alarm means may comprise a plurality of alarm lamps arranged in a straight array which flash on or off in strict accordance with voice counts in arranged order. The visual alarm means may comprise a digital display panel capable of displaying a numerical character altering in descending order. The digital display panel may be disposed in an optical axis of the viewfinder 5 or may be disposed so that the numerical character overlaps a subject image in the viewfinder 5. It is of course allowed to incorporate the visual alarm means only in the camera 2.

FIG. 6 shows a camera equipped with voice alarm means which includes an earphone through which voice counts are heard by a photographer. Specifically, the camera body 3 is provided with a voice generation unit such as shown by a numeral 31 in FIG. 3 and a voice output terminal jack 37 installed in a side wall thereof and connected to the voice generation unit 31 into which a jack plug 38a of an earphone 38 is plugged. The photographer can hear voice counts through the earphone 38. The earphone 38 may be of a pullout type or may be replaced with a headphone.

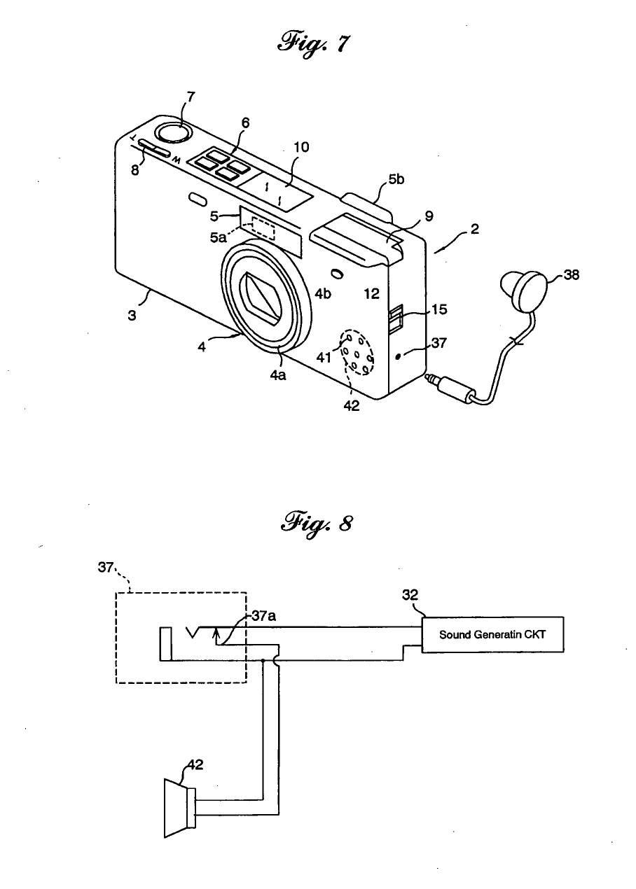

FIG. 7 shows a camera equipped with dual voice alarm means as alarm means. A camera body 3 has sound holes 41 formed in the front wall thereof and is provided with a speaker 42 disposed behind the sound holes 41 therein and a voice output terminal jack 37 installed in the side wall thereof into which an earphone 38 is detachably connected through a jack plug 38a. As shown in FIG. 8, the speaker 42 at one of its terminals is connected to a contact 37a of the voice output terminal jack 37 which is disconnected from a voice generation circuit 32 when the jack plug 38a of the earphone 38 is plugged in the voice output terminal jack 37. According to the camera 2 thus structured, the camera 2 enables a photographer to be acquainted with a timing of exposure by a countdown voice through the speaker 42 when the earphone 38 is disconnected from the camera body 3. On the other hand, when the earphone 38 is connected to the voice generation circuit 32 by plugging the earphone jack plug 38a into the voice output terminal jack 37, the speaker 42 is disconnected from the voice generation circuit 32. Thus, the camera 2 enables a photographer to hear a countdown voice through the earphone 38.

In this instance, the voice output terminal jack 37 is used as means for switching audio output means between the speaker 42 and the earphone 38, it may be replaced with any other switching structure known in the art such as means for isolating the speaker 42 from the voice generation circuit 32.

Although it is enough to acquaint a photographer with a timing of exposure in order to enable the photographer to prevent the camera body 3 from causing a camera shake, the camera 2 may be adapted to get subject persons auditorily or visually acquainted with a timing of exposure so as thereby to allow target persons to pose well before or at the timing of exposure. For example, the camera 2 may be provided with two speakers, namely a loudspeaker which sounds loudly enough to get the target persons heard besides the photographer and a whisper speaker which sounds a whisker voice quietly enough to get the photographer only heard.

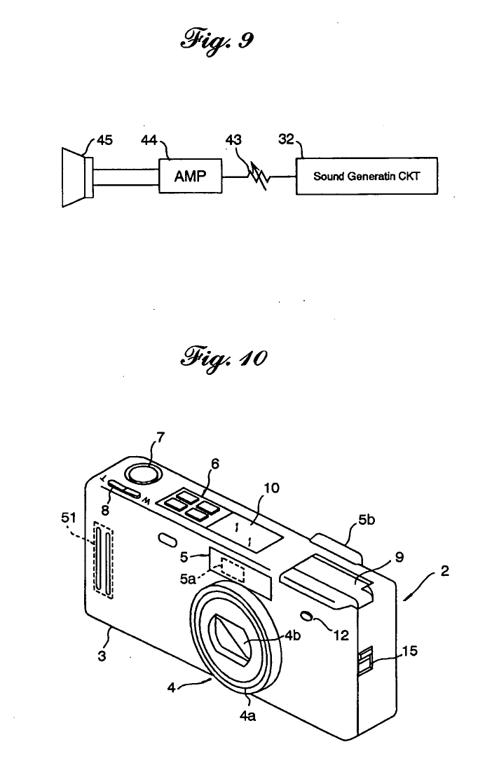

FIG. 9 shows a voice generation means which is capable of adjusting a sound volume of countdown voice. As shown, a speaker 45 is connected to a voice generation circuit 32 through an amplifier 44. A variable resister 43 is incorporated as a volume controller between the voice generation circuit 32 and the amplifier 44. The amplifier 44 is capable of amplifying an input signal at a specified gain, so that a sound volume of the speaker 45 is varied by operating the volume controller, i.e. the variable resister 43. According to the voice generation means thus structured, the sound volume of the speaker 45 can be turned down so that a countdown voice falls on the photographer's ear only or turned up so that a countdown voice falls on both target persons' ears and photographer's ear. The sound volume control may be performed in two levels by a small voice audible for a photographer only and a loud voice audible for both target persons and photographer.

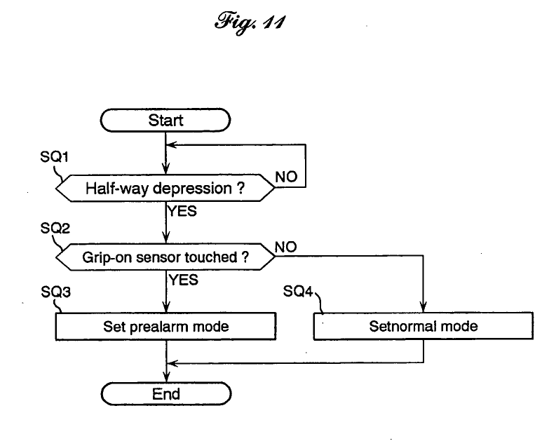

FIG. 10 shows a camera 2 according to still another embodiment of the present invention which is switched between a normal photographic mode and a premonitory photographic mode based on whether hand-held photography is intended or not As shown in FIG. 10, the camera 2 is provided with a grip-on sensor 51 installed in a front wall of a camera body 3 as hand-held photography detection means for detecting whether the photographer takes a grip on the camera body 3 for picture taking. The grip-on sensor 51 provides a mode switch signal when it is touched or grasped by a finger or fingers. As shown by a flowchart illustrating an automatic mode switching sequence in FIG. 11, when the photographer takes a grip on the camera body 3 and then makes half-way depression of the shutter release button 7 in step SQ1, a first switch 22a (see FIG. 3) comes on to provide a preparatory signal which actuates the grip-on sensor 51. When the grip-on sensor 51 is touched or grasped by a finger or fingers in step SQ2 while the shutter release button 7 maintains depressed half way, it provides a mode switch signal for a system controller so as to switch the camera 2 into the premonitory photographic mode in step SQ3. However, in the case where the camera body 3 is not held by hand, for example mounted on a tripod, and the grip-on sensor 51 is not touched or grasped by a finger in step SQ2 even while the shutter release button 7 maintains depressed half way, the camera 2 stays in the normal photographic mode in step SQ4. In this instance, the grip-on sensor 51 may be replaced with a sensor for detecting whether the camera body 3 is mounted on a tripod or whether the photographer views a photographic subject through a viewfinder as the hand-held photography detection means.

Although the above description has been directed to a photographic camera for use with a silver halide film, the present invention is applied to various digital cameras and built-in digital cameras of mobile phones. In the case of such a digital camera, a numerical character varying in descending order may be displayed on a LCD monitor screen of the camera in order to get the photographer acquainted with a timing of exposure.

What is claimed is:

1. An alarm system for a camera changeable between a normal photographic mode in which exposure is made immediately in response to operation of a shutter release button and a premonitory photographic mode in which exposure is made with a delay of time, said alarm system comprising:
signal generating means for generating a trigger signal in response to operation of a release button of said camera for triggering actuation of said exposure means of said camera;
control means for delaying actuation of said exposure means a predetermined period of time from generation of said triggering signal in said premonitory photographic mode; and
prealarm means for raising an alarm for acquainting a photographer with a timing of exposure for said predetermined period of time in said premonitory photographic mode.

2. An alarm system for a camera as defined in claim 1, and further comprising mode switch means for selectively switching the camera between said normal photographic mode and said premonitory photographic mode.

3. An alarm system for a camera as defined in claim 1, wherein said alarm means comprises acoustic alarm means for sounding a voice alarm by which a photographer is acquainted with a timing of exposure.

4. An alarm system for a camera as defined in claim 3, wherein said acoustic alarm means comprises a built-in speaker for delivering a voice alarm and volume control means for controlling a sound volume of said built-in speaker.

5. An alarm system for a camera as defined in claim 4, wherein said volume control means switches said built-in speaker between a small voice audible for a photographer and a loud voice audible for a person to be photographed besides said photographer.

6. An alarm system for a camera as defined in claim 3, wherein said acoustic alarm means comprises an external voice output unit which a photographer wears on photographer's ear to hear a voice alarm.

7. An alarm system for a camera as defined in claim 6, wherein said acoustic alarm means further comprises a voice output terminal installed in a camera body to which said external voice output unit is detachably connected.

8. An alarm system for a camera as defined in claim 7, wherein said acoustic alarm means further comprises a built-in speaker and switch means for rendering only said built-in speaker ineffective when said external voice output unit is connected.

9. An alarm system for a camera as defined in claim 1, wherein said alarm comprises a countdown voice.

10. An alarm system for a camera as defined in claim 1, wherein said alarm comprises a visual numerical character going down in order.

11. An alarm system for a camera as defined in claim 10, wherein said alarm comprises light flashing on and off in synchronism with every count of a countdown.
